(19) United States
(12) Patent Application Publication
(10) Pub. No.: US 2013/0129397 A1
(43) Pub. Date: May 23, 2013

(54) PRINT SYSTEM WITH RIBBON IDENTIFICATION FUNCTION

(71) Applicant: Kai-Min Chu, Taipei City (TW)

(72) Inventor: Kai-Min Chu, Taipei City (TW)

(21) Appl. No.: 13/401,770

(22) Filed: Feb. 21, 2012

(30) Foreign Application Priority Data
Nov. 23, 2011 (TW) 100142871

(51) Int. Cl. B41J 33/34

(52) U.S. Cl. 400/236

(57) ABSTRACT

A print system includes a casing, and a ribbon shaft rotatably installed inside the casing for carrying a ribbon. A plurality of identification regions is formed on the ribbon shaft. The print system further includes a ribbon motor installed inside the casing for driving the ribbon shaft, a sensor installed inside the casing for sensing the plurality of identification regions on the ribbon shaft as the ribbon shaft rotates, and a control unit installed inside the casing and coupled to the sensor and the ribbon motor for determining information of the ribbon according to a sensing result of the plurality of identification regions on the ribbon shaft sensed by the sensor.

### BACKGROUND OF THE INVENTION

1. Field of the Invention

The present invention relates to a print system with ribbon identification function, and more specifically, to a print system capable of identifying information of a ribbon with a plurality of identification regions on a ribbon shaft.

2. Description of the Prior Art

Due to the full tone printing performance, a dye sublimation printer becomes a trend in the printing market. The ribbon identification is often achieved by chip control, for reading ribbon information of a type, an area code, remaining ribbons, and so on, and it has high cost and complicated mechanical design. As for mechanical design to read information stored in the chip by means of contact with a circuit board, a cam mechanism is often used for separating the circuit board during printing, so as to increase manufacture cost and complexity of mechanical design. Even a radio frequency (RF) Chip can be utilized for solving the above-mentioned problems, but it has expensive cost and can not apply for mass production. Therefore, there is a need to provide ribbon identification mechanism with low cost and simply mechanical design in the print industry.

### SUMMARY OF THE INVENTION

The present invention provides a print system capable of identifying information of a ribbon with a plurality of identification regions on a ribbon shaft to solve the problems mentioned above.

According to the claimed invention, a print system includes a casing, and a ribbon shaft rotatably installed inside the casing for carrying a ribbon. A plurality of identification regions is formed on the ribbon shaft . The print system further includes a ribbon motor installed inside the casing for driving the ribbon shaft, a sensor installed inside the casing for sensing the plurality of identification regions on the ribbon shaft as the ribbon shaft rotates, and a control unit installed inside the casing and coupled to the sensor and the ribbon motor for determining information of the ribbon according to a sensing result of the plurality of identification regions on the ribbon shaft sensed by the sensor.

According to the claimed invention, each identification region includes a beginning zone, a terminal zone, and a recognition zone connected to the beginning zone and the terminal zone, and the beginning zone and the terminal zone of the different identification regions are adjacent.

According to the claimed invention, a notch is formed on the beginning zone and the terminal zone is a closed zone.

According to the claimed invention, a notch is formed on the recognition zone or the recognition zone is a closed zone.

According to the claimed invention, the plurality of identification regions is arranged in a radial array.

According to the claimed invention, an initial region is further formed on the ribbon shaft and connected to two terminal identification regions of the plurality of identification regions.

According to the claimed invention, the initial region is a closed region.

According to the claimed invention, the initial region and the plurality of identification regions are arranged in a radial array.

According to the claimed invention, the sensor is an optical interrupter, and the control unit is for determining the information of the ribbon according to the sensing result of whether the plurality of identification regions on the ribbon shaft interrupts light, sensed by the sensor.

According to the claimed invention, the print system further includes a decoding module connected to the ribbon motor for converting rotational speeds of the ribbon motor and the ribbon shaft.

According to the claimed invention, the decoding module includes a wheel connected to the ribbon motor. A plurality of openings is formed on the wheel. The decoding module further includes a sensing component for sensing the plurality of openings formed on the wheel.

According to the claimed invention, the sensing component is an optical interrupter.

According to the claimed invention, the print system is a dye sublimation print system.

The print system of the present invention utilizes the identification regions on the ribbon shaft to determine information of the ribbon, such as a type, an area code, and so on. It can save the chip with high cost and the cam mechanism with complicated mechanical design in the prior art, so as to provide ribbon identification mechanism with low cost and simply mechanical design in the print industry.

These and other objectives of the present invention will no doubt become obvious to those of ordinary skill in the art after reading the following detailed description of the embodiment that is illustrated in the various figures and drawings.

### BRIEF DESCRIPTION OF THE DRAWINGS

FIG. 1 is a functional block diagram of a print system according to a preferred embodiment of the present invention.

FIG. 2 is a schematic drawing of a ribbon shaft being installed inside a casing 52 according to the preferred embodiment of the present invention.

FIG. 3 is a schematic drawing of the ribbon shaft having been installed inside the casing according to the preferred embodiment of the present invention.

FIG. 4 is a diagram of a ribbon motor and a decoding module according to the preferred embodiment of the present invention.

FIG. 5 is a diagram of the ribbon shaft according to the preferred embodiment of the present invention.

FIG. 6 is a lateral view of the ribbon shaft according to the preferred embodiment of the present invention.

FIG. 7 is a diagram of a plurality of identification regions on the ribbon shaft according to the preferred embodiment of the present invention.

### DETAILED DESCRIPTION

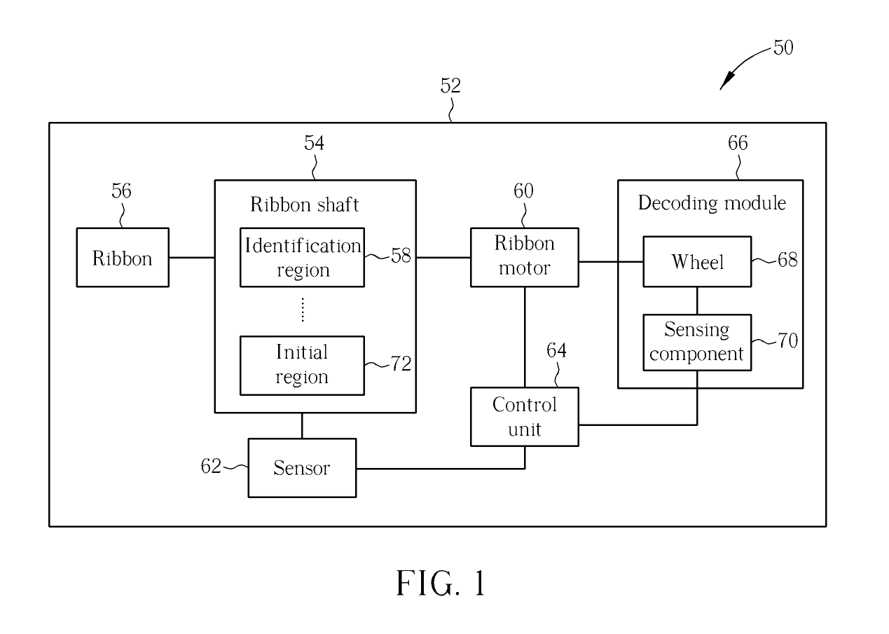

Please refer to FIG. 1. FIG. 1 is a functional block diagram of a print system 50 according to a preferred embodiment of the present invention. The print system 50 can be a dye sublimation print system. The print system 50 includes a casing 52 for covering internal components. The print system 50 further includes a ribbon shaft 54 rotatably installed inside the casing 52 for carrying a ribbon 56. A plurality of identification regions 58 is formed on the ribbon shaft 54. The print system 50 further includes a ribbon motor 60 installed inside the casing 52 for driving the ribbon shaft 54 to rotate. The ribbon motor 60 can be a DC motor. The print system 50 further includes a sensor 62 installed inside the casing 52 for sensing the plurality of identification regions 58 on the ribbon shaft 54 as the ribbon shaft rotates 54. The print system 50 further includes a control unit 64 installed inside the casing 52 and coupled to the sensor 62 and the ribbon motor 60 for determining information of the ribbon 56, such as a type, an area code, remaining ribbons, and so on, according to a sensing result of the plurality of identification regions 58 on the ribbon shaft 54 sensed by the sensor 62.

The sensor 62 can be an optical interrupter, and the control unit 64 can be for determining the information of the ribbon 56 according to the sensing result of whether the plurality of identification regions 58 on the ribbon shaft 54 interrupts light, sensed by the sensor 62. Additionally, the print system 50 can selectively include a decoding module 66 connected to the ribbon motor 60 for converting rotational speeds of the ribbon motor 60 and the ribbon shaft 54, so that the control unit 64 can determine the plurality of identification regions 58 on the ribbon shaft 54 precisely. For example, the decoding module 66 can include a wheel 68 and a sensing component 70. The wheel 68 is connected to the ribbon motor 60, and a plurality of openings 681 is formed on the wheel 68. The sensing component 70 can sense the plurality of openings 681 formed on the wheel 68 as the ribbon motor 60 drives the wheel 68 to rotate, for converting rotating angles of the ribbon motor 60 and the ribbon shaft 54 so as to get a rotational distance of the ribbon shaft 54. The sensing component 70 can be an optical interrupter.

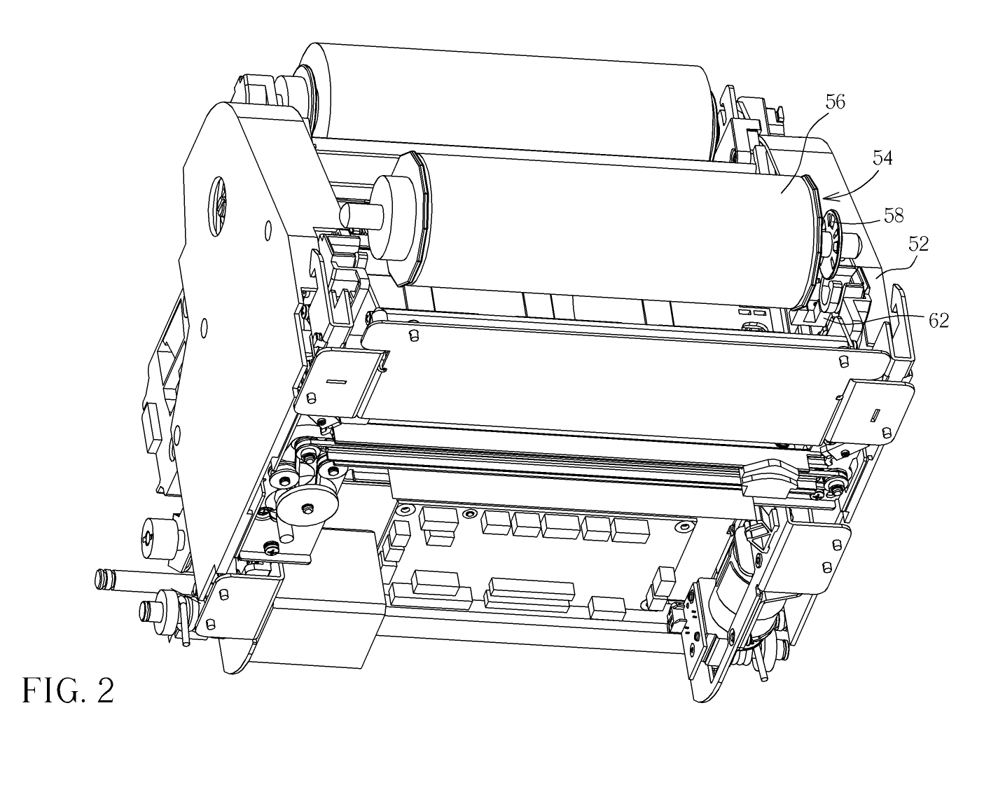

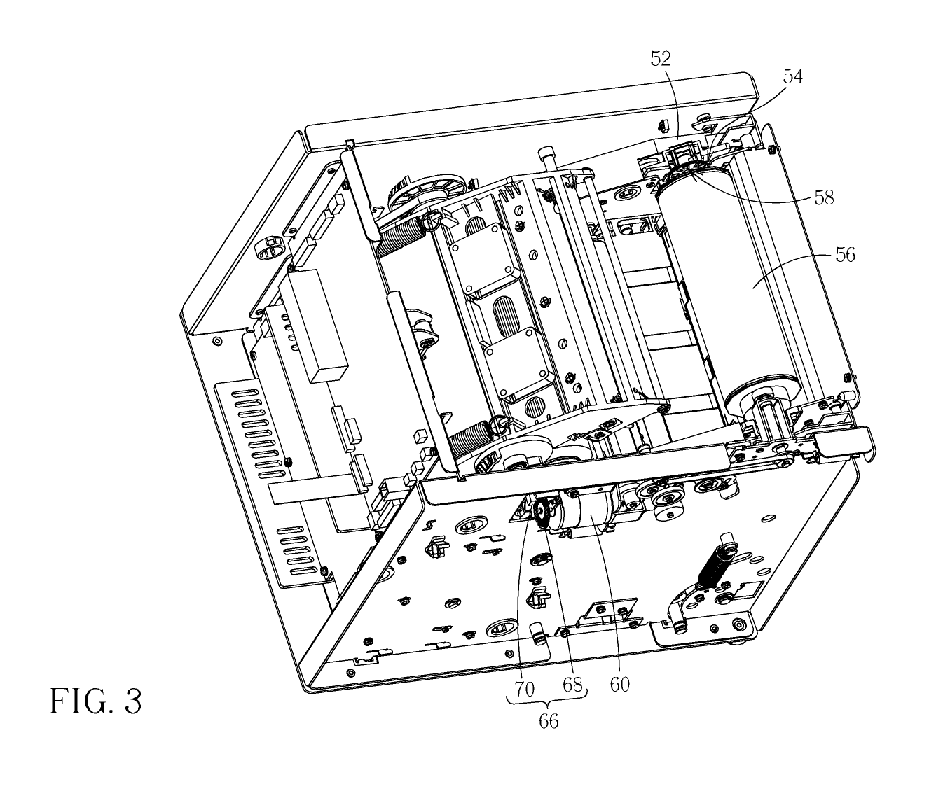

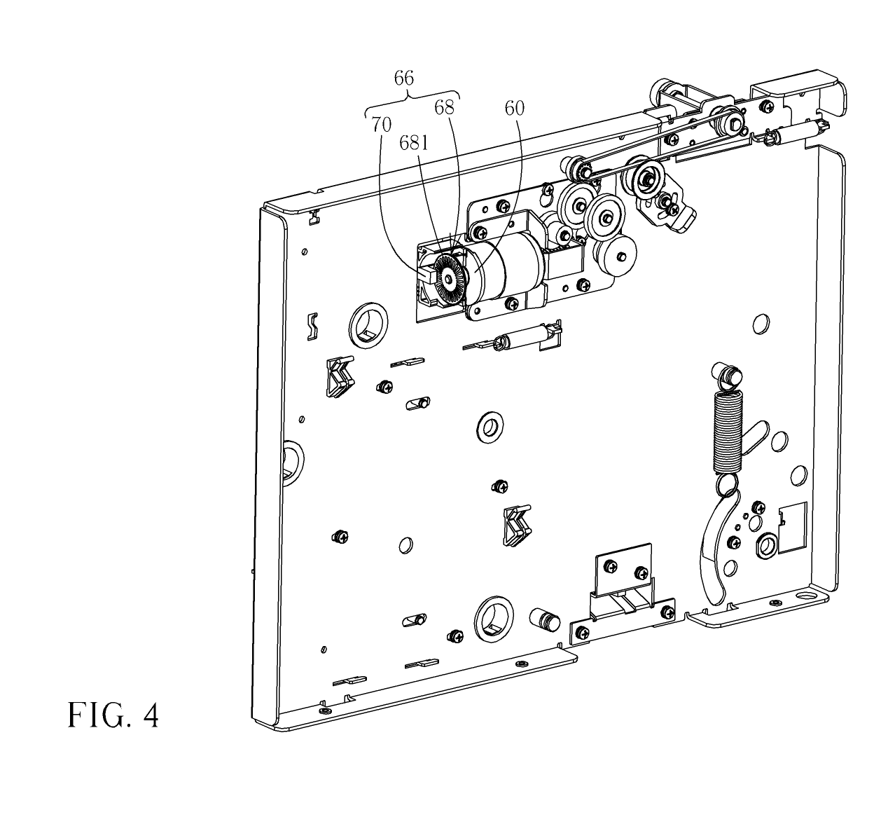

Please refer to FIG. 2 to FIG. 4. FIG. 2 is a schematic drawing of the ribbon shaft 54 being installed inside the casing 52 according to the preferred embodiment of the present invention. FIG. 3 is a schematic drawing of the ribbon shaft 54 having been installed inside the casing 52 according to the preferred embodiment of the present invention. FIG. 4 is a diagram of the ribbon motor 60 and the decoding module 66 according to the preferred embodiment of the present invention. Two ends of the ribbon shaft 54 for carrying the ribbon 56 can be pivoted to an inner side of the casing 52 so that the ribbon 56 can be conveyed to a printing area. The plurality of identification regions 58 formed on a side of the ribbon shaft 54 is located in a position corresponding to the sensor 62 as the ribbon shaft 54 has been installed inside the casing 52. Therefore, the sensor 62 can sense the plurality of identification regions 58 on the ribbon shaft 54 as the ribbon motor 60 drives the ribbon shaft 54 to rotate, so that the control unit 64 can determine the information of the ribbon 56. For clearly illustrating relation of the ribbon motor 60 and the decoding module 66, other components are omitted herein in FIG. 4. When the ribbon motor 60 drives the wheel 68 to rotate, the sensing component 70 can sense the plurality of openings 681 formed on the wheel 68 for converting rotating angles of the ribbon motor 60 and the ribbon shaft 54, wherein rotational speeds of the wheel 68 and the ribbon shaft 54 are different due to a reduction ratio of the ribbon motor 60 and the ribbon shaft 54. Thus, a rotational distance of the wheel 68 can be obtained with the plurality of openings 681 on the wheel 68 sensed by the sensing component 70, so as to obtain the rotational distance of the ribbon shaft 54 according to a predetermined rotational relationship.

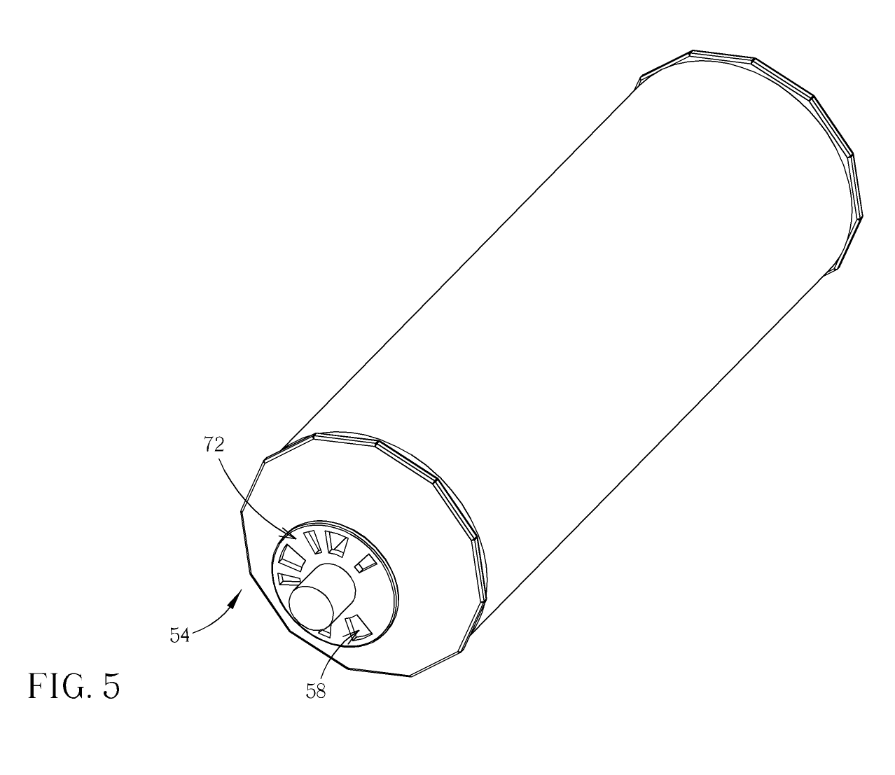

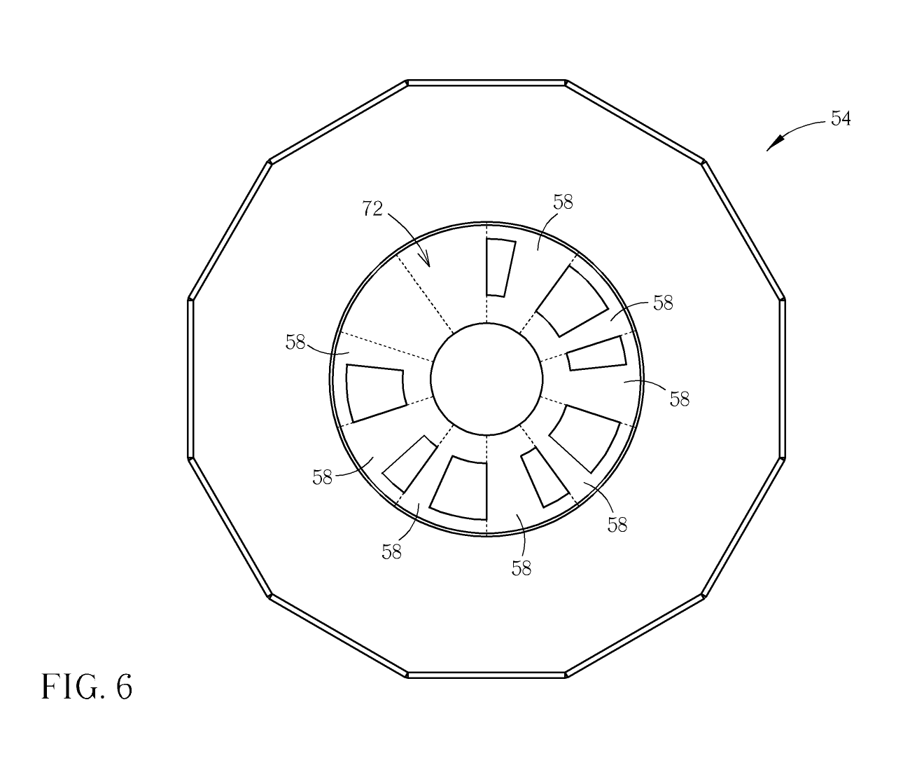

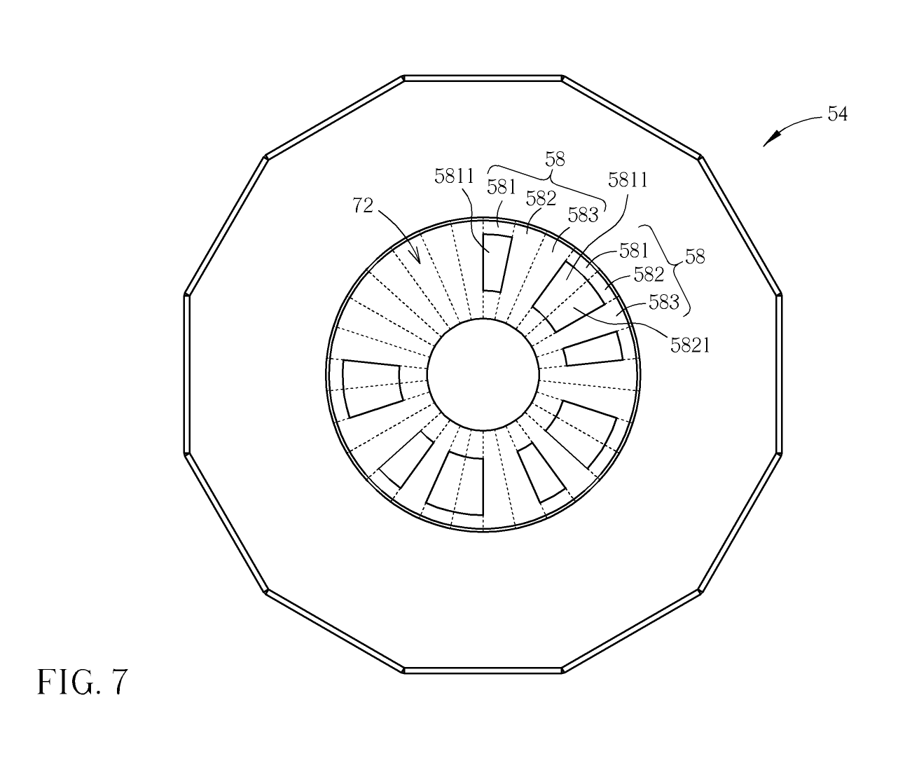

Please refer to FIG. 5 to FIG. 7 . FIG. 5 is a diagram of the ribbon shaft 54 according to the preferred embodiment of the present invention. FIG. 6 is a lateral view of the ribbon shaft 54 according to the preferred embodiment of the present invention. FIG. 7 is a diagram of the plurality of identification regions 58 on the ribbon shaft 54 according to the preferred embodiment of the present invention. Each identification region 58 includes a beginning zone 581, a recognition zone 582 and a terminal zone 583. Each recognition zone 582 is connected to the beginning zone 581 and the terminal zone 583 of the same identification region 58, and the beginning zone 581 and the terminal zone 583 of the different identification regions 58 are adjacent. That is, the identification regions 58 are arranged continuously. For example, the plurality of identification regions 58 can be arranged in a radial array. Furthermore, an initial region 72 can be further formed on the ribbon shaft 54 and be connected to two terminal identification regions of the plurality of identification regions 58, as an initial reference. The initial region 72 and the plurality of identification regions 58 also can be arranged in a radial array, and the initial region 72 can be a closed region. For separating the different identification regions 58, a notch 5811 can be formed on the beginning zone 581 and the terminal zone 583 can be a closed zone, or the beginning zone 581 can be a closed zone and a notch can be formed on the terminal zone 583, so as to distinguish the terminal zone 583 of the previous identification region 58 from the beginning zone 581 of the next identification region 58. Additionally, a notch 5821 can be formed on the recognition zone 582, or the recognition zone 582 can be a closed zone, so as to recognize the corresponding identification region 58.

The ribbon identification mechanism of the present invention is introduced as follows. For example, if the reduction ration of the ribbon motor 60 and the ribbon shaft 54 is 27.3 and there are thirty openings 681 on the wheel 68 connected to the ribbon motor 60, the ribbon shaft 54 rotates for 360 degrees as the wheel 68 rotates for 819 units (27.3*30=819) . That is, when the ribbon shaft 54 rotates for 12 degrees, the wheel 68 rotates for 27.3 units (819*12/360=27.3). As shown in FIG. 7, the ribbon shaft 54 can be divided into 30 units of a circle, and one unit corresponds to 12 degrees. The beginning six units belong to the initial region 72, and the remaining twenty-four units belong to the plurality of identification regions 58. Additionally, each identification region 58 can be divided into three units respectively corresponding to the beginning zone 581, the recognition zone 582 and the terminal zone 583. In conclusion, the ribbon shaft 54 includes one initial region 72 for the initial reference, and eight identification regions 58 for identification. The notch or the close structure of each identification region 58 can correspond to two kinds of identification codes, so that the ribbon shaft 54 can include 2⁸ kinds of identification codes corresponding to different information of the ribbon 56, for achieving ribbon identification function of the present invention. It can start to read identification codes as the decoding module 66 continues reading about 168.3 units (6*27.3=163.8) and the sensor 62 senses the close structure of the initial region 72. Then a sensing result of the sensor 62 can be recorded every 27.3 units or about 27.3 units read by the decoding unit 66. For example, the signal can correspond to 0 as receiving light, and the signal can correspond to 1 as not receiving light. The identification codes corresponding to the eight identification regions 58 can be obtained after repeating the above procedure. The obtained identification codes can be compared with predetermined identification codes stored in the print system 50 so as to get the corresponding information of the ribbon 56.

The decoding module 66 of the present invention can be selectively utilized. For example, the relationship of the rotational speeds of the ribbon motor 60 and the ribbon shaft 54 can be obtained by using a step motor to drive the ribbon shaft 54, or the signals corresponding to different units can be distinguished by detecting a light penetration period. It depends on actual design demand. In addition, a reduction ratio of the ribbon motor 60 and the ribbon shaft 54, an amount of the openings 681 on the wheel 68, an amount of the divided units of the ribbon shaft 54, and an amount and disposal of the initial region 72 and the identification region 58 are not limited to those mentioned above, and all mechanisms with the identification regions for ribbon identification are within the scope of the present invention.

In contrast to the prior art, the print system of the present invention utilizes the identification regions on the ribbon shaft to determine information of the ribbon, such as a type, an area code, and so on. It can save the chip with high cost and the cam mechanism with complicated mechanical design in the prior art, so as to provide ribbon identification mechanism with low cost and simply mechanical design in the print industry.

Those skilled in the art will readily observe that numerous modifications and alterations of the device and method may be made while retaining the teachings of the invention.

What is claimed is:

1. A print system, comprising:
a casing;
a ribbon shaft rotatably installed inside the casing for carrying a ribbon, a plurality of identification regions being formed on the ribbon shaft;
a ribbon motor installed inside the casing for driving the ribbon shaft to rotate;
a sensor installed inside the casing for sensing the plurality of identification regions on the ribbon shaft as the ribbon shaft rotates; and
a control unit installed inside the casing and coupled to the sensor and the ribbon motor for determining information of the ribbon according to a sensing result of the plurality of identification regions on the ribbon shaft sensed by the sensor.

2. The print system of claim 1, wherein each identification region comprises a beginning zone, a terminal zone, and a recognition zone connected to the beginning zone and the terminal zone, and the beginning zone and the terminal zone of the different identification regions are adjacent.

3. The print system of claim 2, wherein a notch is formed on the beginning zone and the terminal zone is a closed zone.

4. The print system of claim 3, wherein a notch is formed on the recognition zone.

5. The print system of claim 3, wherein the recognition zone is a closed zone.

6. The print system of claim 1, wherein the plurality of identification regions is arranged in a radial array.

7. The print system of claim 1, wherein an initial region is further formed on the ribbon shaft and connected to two terminal identification regions of the plurality of identification regions.

8. The print system of claim 7, wherein the initial region is a closed region.

9. The print system of claim 7, wherein the initial region and the plurality of identification regions are arranged in a radial array.

10. The print system of claim 1, wherein the sensor is an optical interrupter, and the control unit is for determining the information of the ribbon according to the sensing result of whether the plurality of identification regions on the ribbon shaft interrupts light, sensed by the sensor.

11. The print system of claim 1, further comprising a decoding module connected to the ribbon motor for converting rotational speeds of the ribbon motor and the ribbon shaft.

12. The print system of claim 11, wherein the decoding module comprises:
a wheel connected to the ribbon motor, a plurality of openings being formed on the wheel; and
a sensing component for sensing the plurality of openings formed on the wheel.

13. The print system of claim 12, wherein the sensing component is an optical interrupter.

14. The print system of claim 1, being a dye sublimation print system.
